(19) United States
(12) Patent Application Publication
(10) Pub. No.: US 2009/0166287 A1
(43) Pub. Date: Jul. 2, 2009

(54) Fuel Filter and Process for Producing Fuel Filter

(75) Inventors: Otto Korst, Seck (DE); Eduard-Siegfried Senden, Wiesbaden (DE)

Correspondence Address: COHEN, PONTANI, LIEBERMAN & PAVANE LLP, 551 FIFTH AVENUE, SUITE 1210, NEW YORK, NY, 10176, US

(73) Assignee: Continental Automotive GmbH, Hannover (DE)

(21) Appl. No.: 12/225,226

(22) PCT Filed: Feb. 14, 2007
(86) PCT No.: PCT/EP2007/051424

§ 371 Date: Sep. 16, 2008

(30) Foreign Application Priority Data
Mar. 16, 2006 (DE) 10 2006 012 214.3

(51) Int. Cl. B01D 35/02; B29C 45/14

(52) U.S. Cl. 210/459; 264/257; 264/138

(57) ABSTRACT

Presented is a fuel filter that includes a filter fabric and a plastic support body. The plastic support body includes a pump connection stub, and a first filter part that includes a first surface and a first peripheral edge that accommodates the filter fabric. The first surface faces away from the filter fabric. The plastic support body further includes a second filter part that includes a second surface and a second peripheral edge that accommodates the filter fabric. The second surface faces away from the filter fabric. The plastic support body further includes connecting elements disposed on the first and second filter parts. When the first filter part and the second filter part are joined, the connecting elements interact with each other and the first surface contacts the second surface.

The subject matter of the invention is a fuel filter, comprising a filter fabric, a support body which consists of plastic and a pump connection stub arranged thereon, and a process for producing a fuel filter, wherein the support body is injected onto the filter fabric and the filter fabric is subsequently folded into the final shape. The fuel filter serves to filter liquid fuels, preferably as a preliminary pump filter of a fuel pump in a fuel tank.

A fuel filter of this type is known from EP 0 400 170 A1. First of all, the outer dimensions of the filter fabric are punched out. At the same time, the intake opening in the region of the pump connection stub is punched out. The filter fabric is subsequently placed into an injection molding machine, and the support body with the pump connection stub is injected. After removal from the injection molding machine, the filter fabric is folded around the support body into its final shape and welded at its edges. A disadvantage of this fuel filter is the relatively high outlay on producing the filter with the welded edges which merely enlarge the outer dimensions of the fuel filter, but without deploying a filter effect. Furthermore, the handling of the flexible filter fabric after injection molding until welding of the edges considerably increases the outlay on producing the fuel filter.

The invention is therefore based on the object of providing a fuel filter which can be produced cost-effectively and a process for producing a fuel filter of this type.

The first object is achieved in that the support body comprises a first filter part and a second filter part, in that the two filter parts each have a peripheral edge which accommodates a filter fabric, and in that connecting elements are arranged on the two filter parts in such a manner that, when the two filter parts are joined, those surfaces of the two filter parts which face away from the filter fabric come into contact with each other such that the connecting elements of the two filter parts interact with one another.

The two-part design of the support body with a first and a second filter part, in which one surface is covered in a sealing manner by the filter fabric, permits a fuel filter to be produced in a particularly simple manner by those surfaces of the filter parts which face away from the filter fabric being brought into contact with each other. The two filter parts are fixed to each other by means of the connecting elements. As a result, with the fuel filter according to the invention, the two layers of the filter fabric do not need to be welded. The retaining force of the connecting elements is additionally reinforced by the plastic swelling.

When the fuel filter is used as a preliminary pump filter, the forces which act on it during operation are relatively small, and therefore the connecting elements can be of correspondingly small dimensions. In an advantageous refinement, the connecting elements are designed as latching and plug-in elements.

A particularly simple process ensues if the latching and plug-in elements are at least two latching hooks which are arranged on a filter part and interact with latching points, which are designed as projections, on the other filter part.

The latching and plug-in elements require particularly little additional construction space if the edge of the one filter part as latching hook has a radially encircling bead which interacts with a radially encircling groove, which acts as latching point, on the edge of the other filter part.

In another refinement, weakening of the wall strength by the arrangement of a groove is avoided if the latching point is likewise a radially encircling bead, with each bead being arranged on the edge in such a manner that it engages behind the respectively other bead in the joined state.

According to another refinement, latching and plug-in elements having undercuts are avoided if the connecting elements on one filter part are designed as formations which point in the direction of the other filter part and form an interference fit with mating surfaces on the other filter part in the joined state.

The formations on the edge of the one filter part can be produced with little outlay if they are of encircling design on the edge, and the mating surface is the edge of the other filter part.

A reduced use of material is achieved by a refinement in which the formations are arranged at a distance from each another on the edge of the one filter part, and the mating surfaces are pockets formed in the edge of the other filter part.

The joining of the two filter parts proves particularly simple if the formations and/or the mating surfaces are designed with a cross section which decreases in the direction of the respectively other filter part.

The second object is achieved according to the invention in that a first filter part and a second filter part of the support body are injected by their respectively encircling edges onto a filter fabric, in that connecting elements are injected onto the filter parts, and in that the two filter parts are subsequently brought into contact with each other by their surfaces which face away from the filter fabric, with the two filter parts being fixed to each other by the connecting elements.

With the injection of the respectively encircling edges of the filter parts forming the support body, the filter fabric is connected to the filter parts in a sealing manner. The filter fabric therefore has its final shape in the region of the fuel filter. Subsequent handling of the flexible filter fabric in order to bring it into its final shape is therefore avoided.

In an advantageous refinement, the filter fabric is supplied to the injection molding machine in the form of endless material, thus permitting automated production of the fuel filter. In addition, simply by specific selection of the filter fabric in respect of mesh size and material, the process permits the fuel filter to be adapted in a specific manner to desired parameters without a far-reaching intervention in the production process having to be made.

In a further simplification of the process according to the invention, the two filter parts, oriented next to each other and at a distance from each other, are injected onto the filter fabric, on one side thereof. The filter fabric is subsequently folded through 180° perpendicularly to the direction of movement between the two filter parts such that the two filter parts come into contact with each other. The joining of the two filter parts to provide the finished fuel filter thereby turns out to be particularly simple. The process permits the use of an injection molding machine with a two-cavity die, i.e., with each injection molding operation, two filter parts which are to be joined to form a fuel filter are produced. By changing to other injection molding dies of the injection molding machine, a large number of different fuel filters can be produced. The process is therefore particularly suitable for adaptation flexibly to different fuel filter designs.

An increase in the productivity is achieved with the use of an injection molding machine with a four-cavity die which is designed in such a manner that duplicate designs of one filter part oriented next to each other and at a distance from each other are injected in the central region of the filter fabric web. The respectively other filter part is injected in the outer region of the filter fabric web next to the inner filter part. By folding the outer regions of the filter fabric web in the direction of the central region, the filter parts are brought into contact with each other for subsequent joining. Two fuel filters are thereby produced in each section of the filter fabric web.

Folding of the filter fabric web is avoided, in a further refinement of the process, by two separate filter webs being supplied to an injection molding machine, with one filter part being injected onto each filter web. After the injection molding operation, the two filter webs are brought together in such a manner that the two filter parts are brought into contact with each other by their surfaces which face away from the filter fabric, and the finished fuel filter is produced by joining of the two filter parts.

In a further refinement, after the two filter parts are joined, the finished fuel filter is detached from the filter fabric web by the fuel filter being separated along the outer contour of the fuel filter from the projecting filter fabric.

The separating of the projecting filter web is carried out with little outlay with a mechanical cutting tool, preferably by means of punching, or with a laser.

The removal of the filter fabric in the region of the pump connection stub can follow with the separating of the fuel filter from the filter fabric web. However, it is also conceivable to separate said region of the filter fabric from the filter fabric web, preferably by means of punching, even before the filter parts are injected.

The invention is explained in more detail using a plurality of exemplary embodiments. In the drawing

FIGS. 1-5 show a fuel filter according to the invention in various stages of the production process.

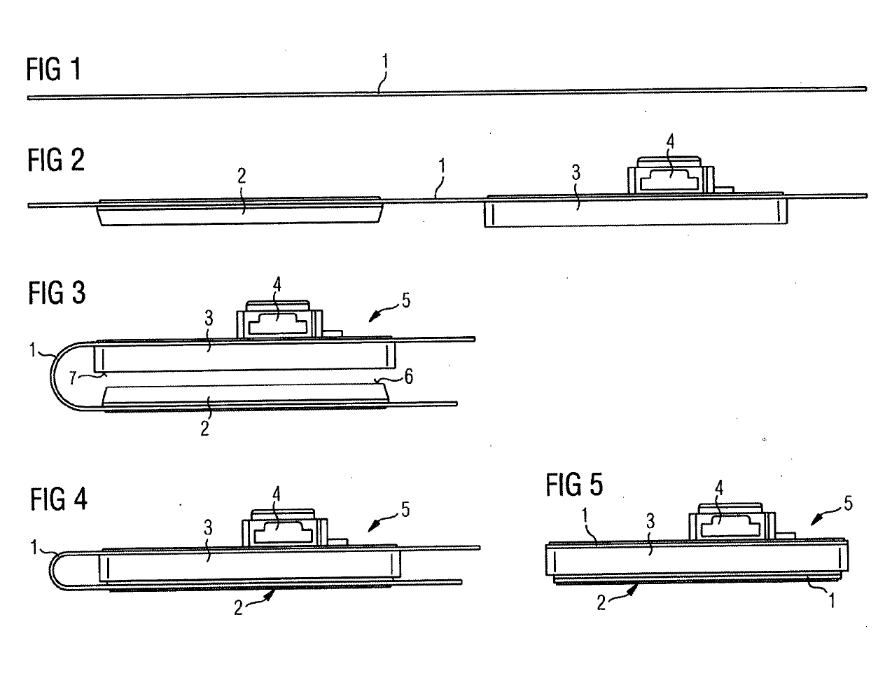

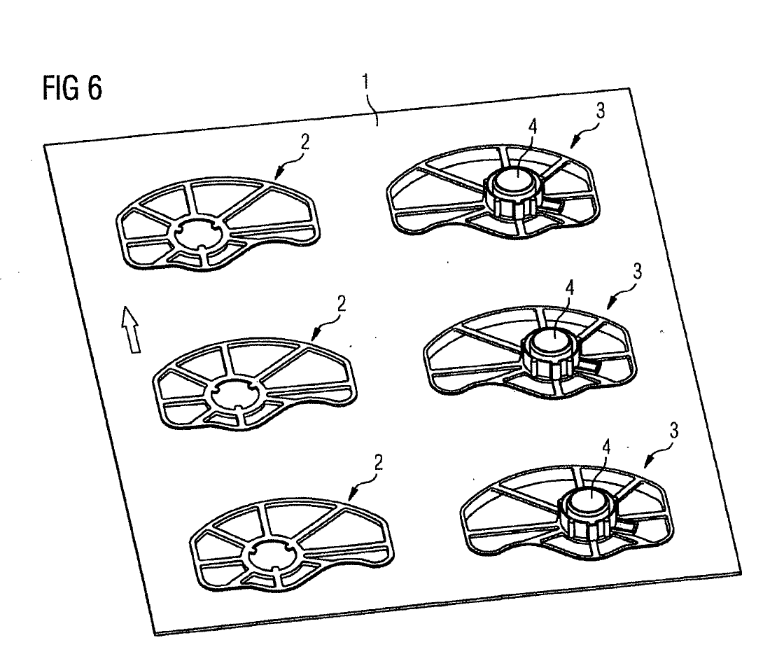

FIG. 6 shows a perspective view of a filter fabric web according to FIG. 2.

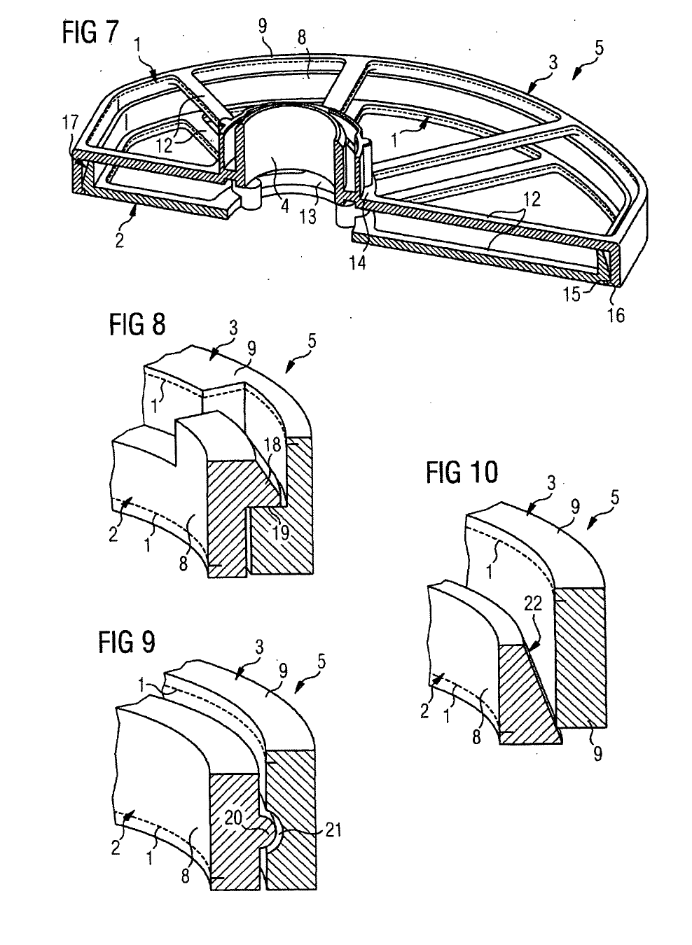

FIG. 7 shows a section through a fuel filter.

FIGS. 8-10 show further embodiments of the connecting elements of the fuel filter in an enlarged illustration.

FIG. 1 shows, in section, a filter fabric web 1 which is supplied in the form of endless material coming from a roll to an injection molding machine (not illustrated). The direction of movement of the filter fabric web is oriented into the plane of the drawing.

FIG. 2 illustrates the filter fabric web 1 after leaving the injection molding machine. In the injection molding machine, two filter parts 2, 3 have been injected onto the filter fabric web 1 next to each other and therefore perpendicularly to the direction of movement thereof in such a manner that the filter fabric 1 substantially covers the respectively upper surface of the filter parts 2, 3.

At the same time, a pump connection stub 4 which serves for the later connection to the intake stub of a fuel pump has been injected on the filter part 3. Those regions of the two filter parts 2, 3 which lie below the filter fabric web 1 form the subsequent support body of the fuel filter 5.

A further process step is illustrated in FIG. 3, according to which the filter fabric web 1 is folded through 180° perpendicularly to the direction of movement such that those surfaces 6, 7 of the filter parts 2, 3 which face away from the filter fabric 1 lie opposite each other and can be brought into contact with each other.

FIG. 4 shows the fuel filter 5 after joining, with the fuel filter 5 still being connected to the filter fabric web 1. For permanent connection of the two filter parts 2, 3, the two filter parts 2, 3 have connecting elements which are described in more detail in FIGS. 6-10.

In the final process step, the fuel filter 5 is separated from the filter fabric web 1, said separating taking place by means of punching. FIG. 5 shows a fuel filter 5 detached in such a way.

FIG. 6 shows the filter fabric web 1 after the filter parts 2, 3 have been injected. The direction of movement of the filter fabric web 1 is indicated by an arrow. The filter parts 2, 3 have a peripheral edge 8, 9. The upwardly facing surface of the filter parts 2, 3 is covered by the filter fabric 1. In order to support the filter fabric 1 and to increase the stability of the fuel filter, struts 12 which surround the filter fabric on both sides are injected on the filter parts 2, 3 in the region of the filter fabric 1.

The fuel filter 5 illustrated in FIG. 7 comprises the two filter parts 2, 3 which form the support body of the fuel filter 5. To reinforce the fuel filter 5 and to support the filter fabric 1, struts 12 are injected on the two filter parts 2, 3. The struts 12 extend from the peripheral edges 8, 9 of the filter parts 2, 3 as far as a respective radially inner support ring 13, 14. On the filter part 3, a pump connection stub 4 is injected on the support ring 14 and is used to plug the fuel filter 5 onto the intake stub of a fuel pump. To better illustrate the filter parts 2, 3, the filter fabric 1 is merely illustrated in the region of the struts 12 and of the edges 8, 9 in the form of a dashed line. As connecting elements, the fuel filter 5 has latching and plug-in elements which are integrally formed in the form of a radially encircling bead 15, 16 on the respective edge 8, 9 of the filter parts 2, 3. Each bead 15, 16 is arranged on the respective edge 8, 9 in such a manner that it engages behind the respectively other bead 16, 15 in the joined state of the filter parts 2, 3. For better joining of the two filter parts 2, 3, the edge 8 of the filter part 2 has a cross section which decreases in the direction of the other filter part 3, as a result of which the radially outer peripheral surface of the edge 8 forms an insertion slope 17.

FIG. 8 shows the fuel filter 5 in the region of the connecting elements in an enlarged illustration. A latching hook 18 which engages in a projection 19, designed as latching point, is integrally formed on the edge 8 of the filter part 2. For illustration reasons, the filter fabric 1 is again illustrated in the form of a dashed line. The latching hook 18 is one of a plurality of connecting elements which are arranged at a distance from one another on the circumference of the filter part 2 and interact with projections distributed in the same manner.

The filter part 2 of the fuel filter illustrated in FIG. 9 has, on the outer side of its edge 8, a radially encircling bead 20 which interacts with a radially encircling groove 21, which acts as latching point, on the inner side of the edge 9 of the filter part 3.

In FIG. 10, a formation 22 is formed in a radially encircling manner on the edge 8 of the filter part 2, with the formation 22 having a cross section which decreases in the direction of the filter part 3. When the two filter parts 2, 3 are joined, said cross section initially acts as insertion slope until the formation 22 strikes against the edge 9 as the mating surface. Further movement of the two filter parts 2, 3 toward each other brings about an interference fit which results in a permanent connection of the two filter parts 2, 3.

1-15. (canceled)

16. A fuel filter, comprising:
a filter fabric; and
a plastic support body comprising:
a pump connection stub;
a first filter part comprising a first surface and a first peripheral edge that accommodates the filter fabric, the first surface facing away from the filter fabric;
a second filter part comprising a second surface and a second peripheral edge that accommodates the filter fabric, the second surface facing away from the filter fabric; and
connecting elements disposed on the first and second filter parts;
wherein when the first filter part and the second filter part are joined, the connecting elements interact with each other and the first surface contacts the second surface.

17. The fuel filter as claimed in claim 16, wherein the connecting elements comprise latching and plug-in elements.

18. The fuel filter as claimed in claim 18, wherein the latching and plug-in elements comprise at least two latching hooks arranged on the first filter part and that interact with latching points formed as projections on the second filter part.

19. The fuel filter as claimed in claim 17, wherein the first peripheral edge comprises a radially encircling bead which functions as a latching hook and the second peripheral edge comprises a radially encircling groove which functions as a latching point, and the radially encircling bead interacts with the radially encircling groove.

20. The fuel filter as claimed in claim 17, wherein the first peripheral edge comprises a first radially encircling bead which functions as a latching hook and the second peripheral edge comprises a second radially encircling bead which functions as a latching point, and the first radially encircling bead engages the second radially encircling bead when the first filter part and the second filter part are joined.

21. The fuel filter as claimed in claim 16, wherein the connecting elements disposed on the first filter part comprise formations and connecting elements on the second filter part comprise mating surfaces, and the formations form an interference fit with the mating surfaces when the first filter part and the second filter part are joined.

22. The fuel filter as claimed in claim 21, wherein the formations are disposed on the first peripheral edge and are formed as an encircling design, and the mating surfaces are disposed on the second peripheral edge.

23. The fuel filter as claimed in claim 21, wherein the formations are arranged at a distance from each other on the first peripheral edge, and the mating surfaces are disposed on the second peripheral edge.

24. The fuel filter as claimed in claim 21, wherein at least one of the formations and the mating surfaces are formed with a cross section which decreases in a direction away from the respective first or second peripheral edge.

25. A process for producing a fuel filter as claimed in claim 16, comprising the steps:
placing a filter fabric into an injection molding die of an injection molding machine;
injecting a support body with a pump connection stub onto the filter fabric, comprising the steps:
injecting a first filter part and a second filter part of the support body by their respectively encircling edges onto the filter fabric; and
injecting connecting elements onto the first and second filter parts;
bringing a surface of the first filter part that faces away from the filter fabric into contact with a surface of the second filter part that faces away from the filter fabric; and
fixing the first filter part to the second filter part by engaging the connecting elements.

26. The process as claimed in claim 25, wherein the step of placing comprises supplying the filter fabric to the injection molding machine in the form of endless material.

27. The process as claimed in claim 25, wherein the first and second filter parts are disposed at a distance from each other on one side of the filter fabric after said step of injecting, and wherein said step of bringing comprises folding the filter fabric after said step of injecting such that the first and second filter parts contact with each other.

28. The process as claimed in claim 25,
wherein said step of injecting comprises injecting each of the first and second filter parts onto a separate filter fabric web; and
wherein said step of bringing comprises joining the first and second filter parts together by bringing a surface of the first filter part that faces away from the filter fabric web into contact with a surface of the second filter part that faces away from the filter fabric web.

29. The process as claimed in claim 25, further comprising separating the filter fabric along an outer contour from a projecting filter fabric after the first filter part and the second filter part are fixed together.

30. The process as claimed in claim 29, wherein said step of separating is accomplished with a mechanical cutting tool or a laser.
